(19) United States
(12) Patent Application Publication
(10) Pub. No.: US 2024/0023619 A1
(43) Pub. Date: Jan. 25, 2024

(54) FLAVOUR INHALER, AND HEATER MANUFACTURING METHOD

(71) Applicant: Japan Tobacco Inc., Tokyo (JP)

(72) Inventors: Ryota MATSUBA, Tokyo (JP); Yasunobu INOUE, Tokyo (JP); Manabu YAMADA, Tokyo (JP)

(73) Assignee: Japan Tobacco Inc., Tokyo (JP)

(21) Appl. No.: 18/480,413

(22) Filed: Oct. 3, 2023

Related U.S. Application Data
(63) Continuation of application No. PCT/JP2021/026424, filed on Jul. 14, 2021.

(51) Int. Cl. A24F 40/46; A24F 40/20; A24F 40/70; H05B 3/22

(52) U.S. Cl. CPC A24F 40/46; A24F 40/20; A24F 40/70; H05B 3/22

(57) ABSTRACT

A flavour inhaler includes a heater having a main surface and an end surface for heating a smokable material. The heater generates heat by the flow of current in the direction orthogonal to the main surface.

### CROSS-REFERENCE TO RELATED APPLICATION

This application is based upon and claims benefit of priority from International Application No. PCT/JP2021/026424 filed on Jul. 14, 2021, the entire contents of which are incorporated herein by reference.

The present invention relates to a flavor inhaler and a method for manufacturing a heater.

### BACKGROUND ART

A known flavor inhaler is used to inhale flavor or the like without burning a material. The flavor inhaler includes, for example, a chamber that accommodates a flavor generating article and a heater that heats the flavor generating article accommodated in the chamber (see PTL 1).

### CITATION LIST

### PATENT LITERATURE

PTL 1: International Publication No. 2020/084775

### SUMMARY OF INVENTION

### TECHNICAL PROBLEM

An external heater such as the one described in PTL 1 includes conductive tracks as resistive heating elements. The external heater according to the related art has the conductive tracks distributed along a plane thereof, and therefore it has been difficult to uniformly heat an outer periphery of the flavor generating article (consumable).

An object of the present invention is to achieve more uniform heating of a smokable material included in a consumable.

### SOLUTION TO PROBLEM

According to a first aspect, a flavor inhaler is provided. The flavor inhaler includes a heater for heating a smokable material, the heater having a main surface and an end surface. The heater is configured to produce heat in response to a current flowing through the heater in a direction orthogonal to the main surface.

According to the first aspect, the heater produces heat in response to a current flowing therethrough in the direction orthogonal to the main surface instead of an in-plane direction of the heater. Therefore, when the resistance of the heater is constant along the plane of the heater, heat can be produced uniformly over a region through which the current flows. In this specification, the main surface may be a surface having an area greater than an area of the end surface. The main surface may also be a surface of the heater having the largest area or a surface that comes into contact with an outer surface of a container when the heater is wrapped around the container.

According to a second aspect, in the first aspect, the heater is disposed to surround the smokable material.

According to the second aspect, the smokable material in a consumable can be uniformly heated from an outer periphery thereof.

According to a third aspect, in the first or second aspect, the flavor inhaler further includes a container that accommodates a consumable including the smokable material. The heater is disposed to surround the container.

According to the third aspect, the smokable material in the consumable accommodated in the container can be more uniformly heated from the outside by the heater.

According to a fourth aspect, in any one of the first to third aspects, the heater includes a heater element and a pair of electrodes disposed on both surfaces of the heater element to allow a current to flow between the pair of electrodes. The heater element is configured to produce heat in response to a current flowing between the pair of electrodes through the heater element in a direction orthogonal to the surfaces of the heater element.

According to the fourth aspect, a region of the heater element on which the electrodes are provided can produce heat in response to a current flowing therethrough in the direction orthogonal to the surfaces of the heater element. In other words, the region of the heater element on which the electrodes are disposed can be used as a heating region. In this specification, the term “electrodes” can mean, for example, portions having a resistance lower than that of the heater element and making a relatively small contribution to production of heat in the heater.

According to a fifth aspect, in the fourth aspect, the electrodes are sheet-shaped and, in plan view of the electrodes, portions of the electrodes that are fixed to the heater element are positioned inside the heater element on the surfaces on which the electrodes are disposed.

According to the fifth aspect, the portions of the sheet-shaped electrodes that are fixed to the heater element are disposed so as not to protrude from the heater element in plan view of the electrodes. Therefore, the pair of electrodes can be prevented from extending beyond the heater element to come into contact with each other.

According to a sixth aspect, in the fourth or fifth aspect, the heater element includes a conductive material and a porous body configured to hold the conductive material.

According to the sixth aspect, the conductive material can be held by being uniformly distributed over the porous body, so that the uniformity of the resistance of the heater element along the plane of the heater element can be increased. In addition, the resistance of the heater element can be easily adjusted by adjusting the type, amount, etc., of the conductive material held by the porous body. Therefore, a heater having a desired resistance can be obtained.

According to a seventh aspect, in the sixth aspect, the porous body is formed of inorganic fibers.

According to the seventh aspect, the heater element can be structured such that the conductive material is held by being uniformly distributed over the porous body and that the heat resistance of the heater element is sufficiently high (for example, 300° C. or more).

According to an eighth aspect, in the seventh aspect, the inorganic fibers are made of an insulating material.

According to the eighth aspect, the volume resistivity of the heater element is not likely to be excessively low. Therefore, the area and thickness of the heater element can be increased, so that a heater that is strong and capable of heating a larger area can be obtained. In addition, the heater can be more easily manufactured.

According to a ninth aspect, in any one of the sixth to eighth aspects, the conductive material includes a substance containing carbon.

According to the ninth aspect, the volume resistivity of the heater element is less likely to be excessively low compared to when the conductive material is made only of a metal material. Therefore, the area and thickness of the heater element can be increased.

According to a tenth aspect, in the ninth aspect, the conductive material includes carbon nanotubes.

According to the tenth aspect, the heater element can be sufficiently heat resistant, and the volume resistivity of the heater element can be easily adjusted by adjusting the length and amount of carbon nanotubes. Therefore, a heating profile close to a desired heating profile can be achieved without greatly changing a voltage applied to the heater element.

According to an eleventh aspect, in any one of the fourth to tenth aspects, at least one of the pair of electrodes includes a conductive adhesive.

According to the eleventh aspect, the conductive adhesive itself can constitute an electrode. Alternatively, the conductive adhesive can be used to bond any conductive member to the heater element as an electrode. In addition, a current can be applied to the heater element through the conductive adhesive, so that the heat capacity of the heater can be reduced compared to when a metal foil is used. Therefore, the heating efficiency of the heater can be increased.

According to a twelfth aspect, in the eleventh aspect, at least one of the pair of electrodes includes a metal foil fixed to the heater element with the conductive adhesive provided therebetween.

According to the twelfth aspect, the heater is covered with the metal foil, so that the heater can be easily wrapped around the container that accommodates the consumable. In addition, the emissivity of the surface of the heater is reduced, so that heat loss due to radiation can be reduced.

According to a thirteenth aspect, in the eleventh or twelfth aspect, the flavor inhaler further includes a conductive element that includes a portion connected to the conductive adhesive and that extends from the conductive adhesive.

According to the thirteenth aspect, a current can be applied to the conductive adhesive and the heater element through the conductive element, so that the heat capacity of the heater can be reduced compared to when a metal foil is used. Therefore, the heating efficiency of the heater can be increased. The portion of the conductive element connected to the conductive adhesive functions substantially as an electrode. In other words, in this specification, the term “conductive element” means a portion of a conductive material that is not fixed (or bonded) to the heater element.

According to a fourteenth aspect, in any one of the fourth to thirteenth aspects, the electrodes extend to a location downstream of a downstream end portion of the smokable material in a length direction of the smokable material.

According to the fourteenth aspect, the downstream end portion of the smokable material can be reliably heated by the heater. Therefore, concentration of vapor or aerosol at the downstream end portion of the smokable material can be reduced, so that the amount of vapor or aerosol that is delivered can be increased.

According to a fifteenth aspect, in any one of the fourth to fourteenth aspects, the heater element has a volume resistivity of 0.1 m·Ω or more and 18 m·Ω or less.

According to the fifteenth aspect, the heater can be formed to have an appropriate thickness and an area corresponding to the size of a widely available consumable, and the heater element can have a resistance such that the smokable material in the consumable can be appropriately heated.

According to a sixteenth aspect, in any one of the fourth to fifteenth aspects as dependent on the third aspect, one of the pair of electrodes includes the container.

According to the sixteenth aspect, a current can be applied to the conductive adhesive and the heater element through the container, so that the heat capacity of the heater can be reduced compared to when a metal foil is used. Therefore, the heating efficiency of the heater can be increased.

According to a seventeenth aspect, in any one of the first to sixteenth aspects, the heater is flexible, and the heater has a minimum bend radius of 3 mm or less.

According to the seventeenth aspect, the heater can be easily bent to surround a widely available consumable or the container that accommodates the widely available consumable.

According to an eighteenth aspect, a method for manufacturing a sheet-shaped heater for heating a smokable material is provided. The method for manufacturing the heater includes: preparing a sheet formed of inorganic fibers; impregnating the sheet with liquid containing a conductive material and causing the sheet to hold the conductive material; and applying a conductive adhesive to the sheet holding the conductive material.

According to the eighteenth aspect, a heater that produces heat in response to a current flowing therethrough in a direction orthogonal to the surface of the heater can be manufactured. According to this heater, the conductive material can be held by being uniformly distributed over the porous body, so that the uniformity of the resistance of the heater along the plane of the heater can be increased. In addition, the resistance of the heater can be easily adjusted by adjusting, for example, the amount of the conductive material held by the porous body. Therefore, a heater having a desired resistance can be obtained. When the sheet is formed of inorganic fibers, the heater can have a sufficient heat resistance (for example, 300° C. or more).

According to a nineteenth aspect, in the eighteenth aspect, the method further comprises bonding a metal foil to the sheet with the conductive adhesive provided therebetween.

According to the nineteenth aspect, the heater is covered with the metal foil, so that the heater can be easily wrapped around the consumable or the container that accommodates the consumable. In addition, the emissivity of the surface of the heater is reduced, so that heat loss due to radiation can be reduced.

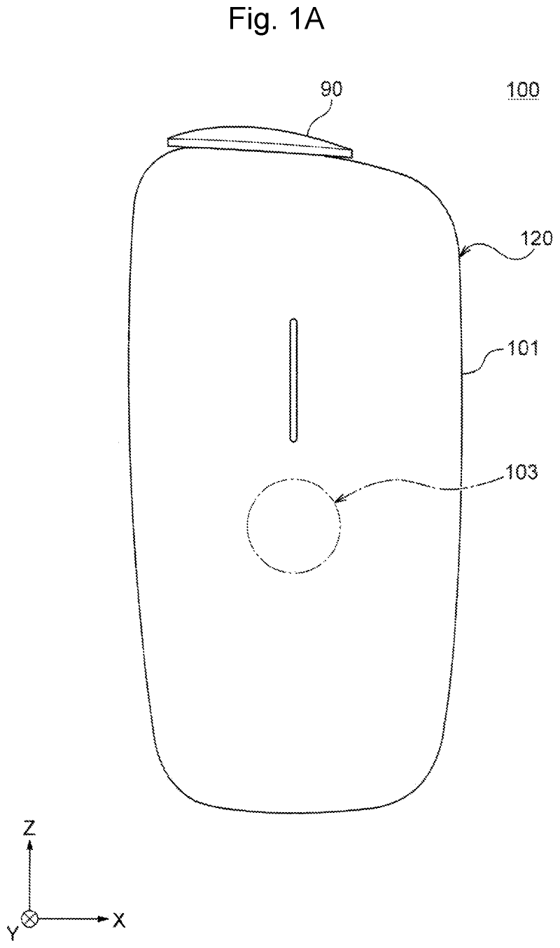

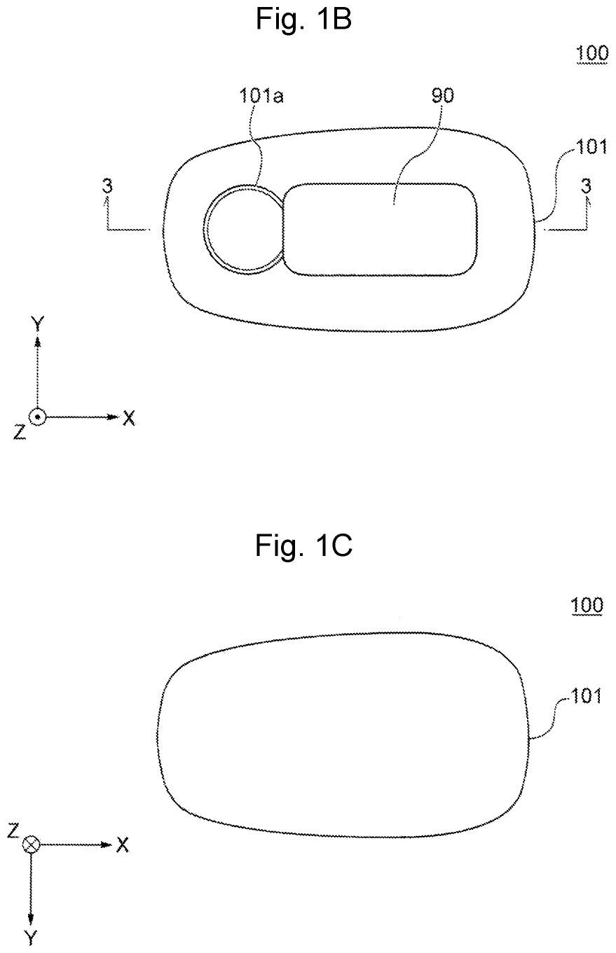

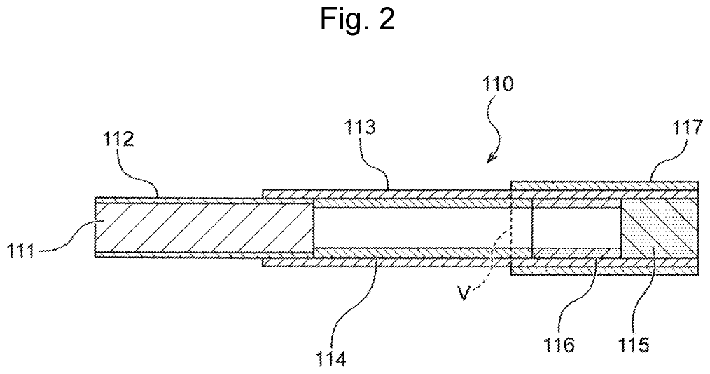

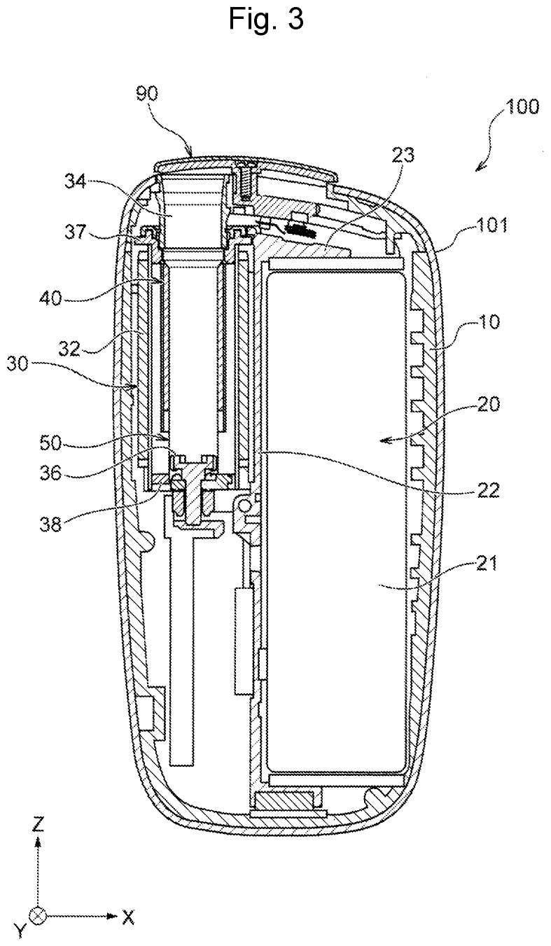

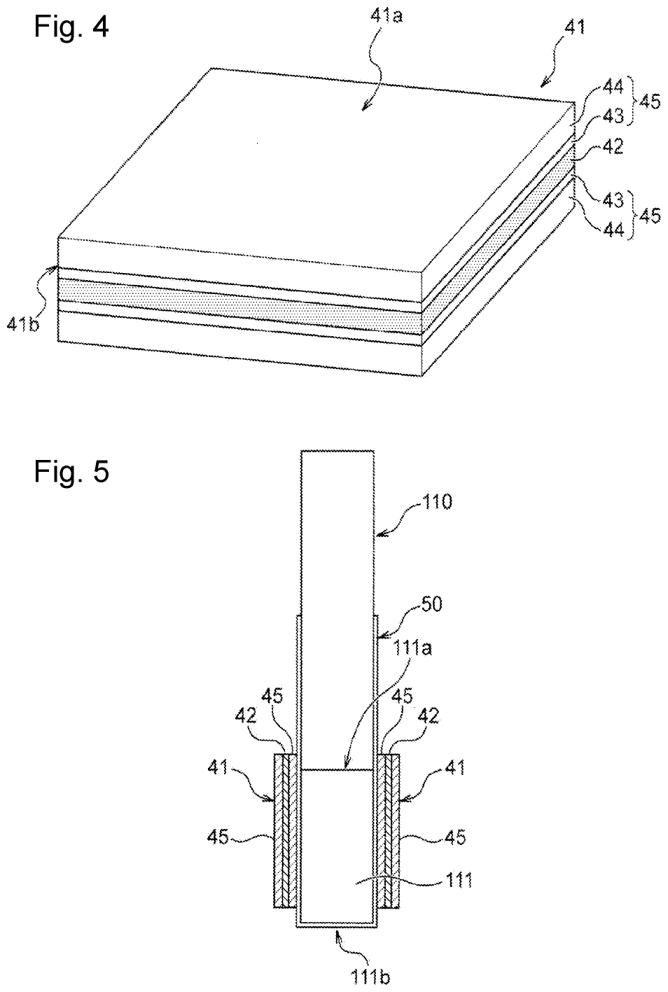

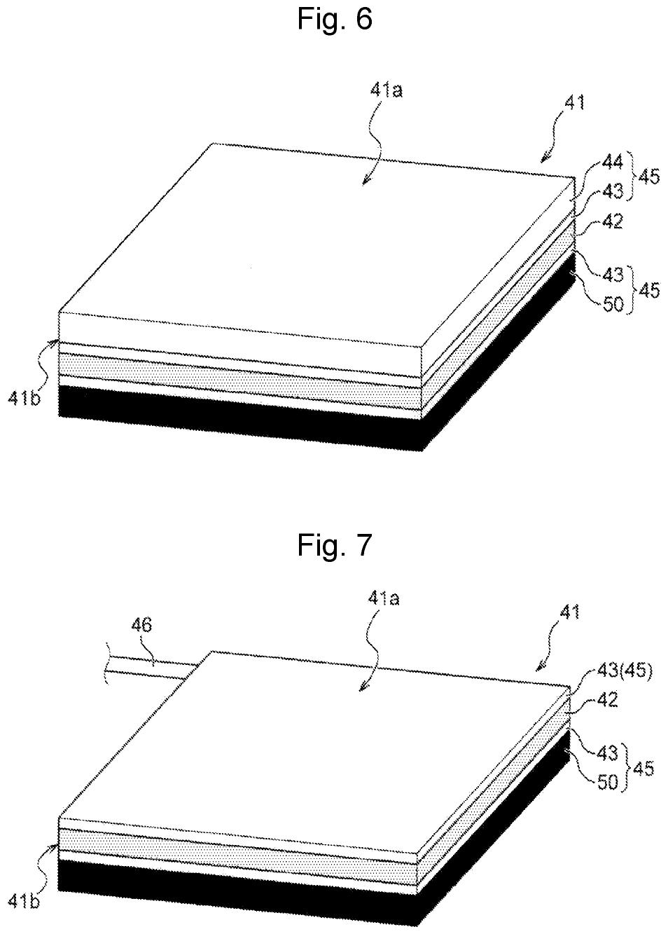

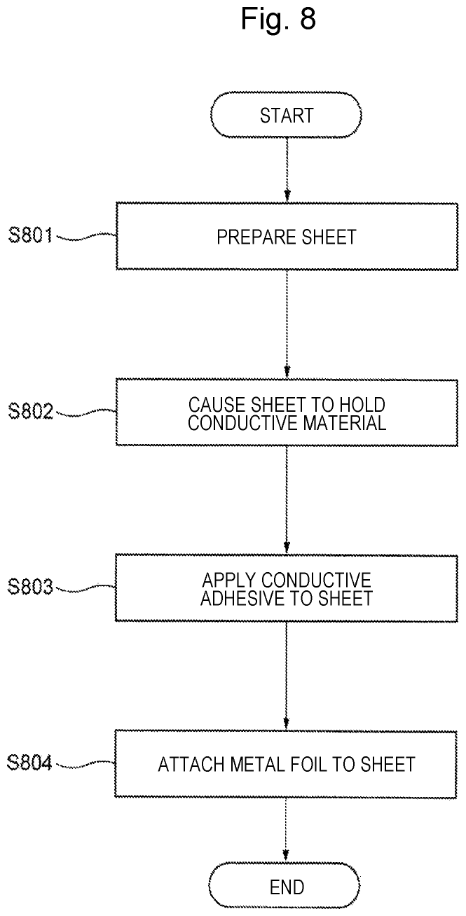

### BRIEF DESCRIPTION OF DRAWINGS

[FIG. 1A] FIG. 1A is a schematic front view of a flavor inhaler according to an embodiment.

[FIG. 1B] FIG. 1B is a schematic top view of the flavor inhaler according to the embodiment.

[FIG. 1C] FIG. 1C is a schematic bottom view of the flavor inhaler according to the embodiment.

[FIG. 2] FIG. 2 is a schematic side sectional view of a consumable.

[FIG. 3] FIG. 3 is a sectional view of the flavor inhaler taken along line 3-3 in FIG. 1B.

[FIG. 4] FIG. 4 is a schematic profile of a heater.

[FIG. 5] FIG. 5 is a schematic sectional view of a chamber in which a consumable is accommodated.

[FIG. 6] FIG. 6 is a schematic profile of a heater according to another embodiment.

[FIG. 7] FIG. 7 is a schematic profile of a heater according to another embodiment.

[FIG. 8] FIG. 8 is a flowchart of a method for manufacturing a heater.

### DESCRIPTION OF EMBODIMENTS

Embodiments of the present invention will now be described with reference to the drawings. In the drawings referred to below, the same or corresponding structural elements are denoted by the same reference signs, and redundant description is omitted.

FIG. 1A is a schematic front view of a flavor inhaler 100 according to an embodiment. FIG. 1B is a schematic top view of the flavor inhaler 100 according to the embodiment. FIG. 1C is a schematic bottom view of the flavor inhaler 100 according to the embodiment. In the drawings referred to in this specification, an X-Y-Z Cartesian coordinate system may be shown to facilitate description. In this coordinate system, the Z-axis extends vertically upward, and an X-Y plane extends to divide the flavor inhaler 100 in a horizontal direction. The Y-axis extends in a direction from a front surface to a back surface of the flavor inhaler 100. The Z-axis may also be regarded as extending in a direction in which a consumable is inserted into a chamber 50 of an atomizing unit 30 described below, or an axial direction of the chamber 50. The X-axis direction may also be regarded as a longitudinal direction of the device on a plane orthogonal to the direction of insertion of the consumable, or a direction in which a heating unit and a power supply unit are arranged. The Y-axis direction may also be regarded as a transverse direction of the device on the plane orthogonal to the direction of insertion of the consumable. A direction parallel to the X-Y plane is a direction orthogonal to the axial direction of the chamber 50, and may also be referred to as a radial direction. In this specification, the term “circumferential direction” refers to a circumferential direction around the direction of insertion of the consumable or the axial direction of the chamber 50.

The flavor inhaler 100 according to the present embodiment is configured to generate flavored aerosol when, for example, a stick-shaped consumable including a smokable material containing an aerosol source and a flavor source is heated.

As illustrated in FIGS. 1A to 1C, the flavor inhaler 100 may include a slide cover 90 and a main body 120. The main body 120 includes an outer housing 101 and a switch part 103. The outer housing 101 constitutes an outermost housing of the flavor inhaler 100, and has a size such that the outer housing 101 can be held by a user's hand. A user can use the flavor inhaler 100 by holding the main body 120 in their hand and inhaling aerosol. The outer housing 101 may be formed by assembling a plurality of members.

As illustrated in FIG. 1B, the outer housing 101 has an opening 101a into which the consumable is inserted. The slide cover 90 is slidably attached to the outer housing 101 such that the slide cover 90 covers the opening 101a. More specifically, the slide cover 90 is movable along an outer surface of the outer housing 101 between a closed position (position illustrated in FIG. 1A) at which the slide cover 90 covers the opening 101a in the outer housing 101 and an open position (position illustrated in FIG. 1B) at which the slide cover 90 does not cover the opening 101a. For example, the user can manually operate the slide cover 90 to move the slide cover 90 between the closed position and the open position. Thus, the slide cover 90 allows or blocks access of the consumable to the inside of the flavor inhaler 100.

The switch part 103 is used to turn on and off the operation of the flavor inhaler 100. For example, when the user operates the switch part 103 after the consumable is inserted into the flavor inhaler 100, a heating unit (not illustrated) receives electric power from a power supply (not illustrated) and heats the consumable without burning the consumable. The switch part 103 may include a switch provided on the exterior of the outer housing 101 or a switch disposed on the interior of the outer housing 101. When the switch is disposed on the interior of the outer housing 101, the switch is indirectly depressed when the switch part 103 on the surface of the outer housing 101 is depressed. In the present embodiment, it is assumed that the switch of the switch part 103 is disposed on the interior of the outer housing 101.

The flavor inhaler 100 may additionally include a terminal (not illustrated). The terminal may be an interface that connects the flavor inhaler 100 to, for example, an external power supply. When the power supply included in the flavor inhaler 100 is a rechargeable battery, the power supply can be charged by supplying a current thereto from the external power supply by connecting the external power supply to the terminal. Alternatively, a data transmission cable may be connected to the terminal so that data related to the operation of the flavor inhaler 100 can be transmitted to an external device.

The consumable used in the flavor inhaler 100 according to the present embodiment will now be described. FIG. 2 is a schematic side sectional view of a consumable 110. In the present embodiment, the flavor inhaler 100 and the consumable 110 may constitute a smoking system. In the example illustrated in FIG. 2, the consumable 110 includes a smokable material 111, a cylindrical member 114, a hollow filter 116, and a filter 115. The smokable material 111 is wrapped with first wrapping paper 112. The cylindrical member 114, the hollow filter 116, and the filter 115 are wrapped with second wrapping paper 113 that differs from the first wrapping paper 112. A portion of the first wrapping paper 112 with which the smokable material 111 is wrapped is also wrapped with the second wrapping paper 113. Thus, the cylindrical member 114, the hollow filter 116, and the filter 115 are connected to the smokable material 111. The second wrapping paper 113 may be omitted, and the first wrapping paper 112 may be used to connect the cylindrical member 114, the hollow filter 116, and the filter 115 to the smokable material 111. The cylindrical member 114 and the second wrapping paper 113 that covers the cylindrical member 114 may have perforations V. The perforations V are generally holes for promoting inflow of air from the outside in response to inhalation by the user. The inflow of air serves to reduce the temperature of components and air flowing from the smokable material 111. A lip release agent 117 is applied to an outer surface of an end portion of the second wrapping paper 113 adjacent to the filter 115 to reduce sticking of the second wrapping paper 113 to the user's lips. A portion of the consumable 110 to which the lip release agent 117 is applied functions as an inhalation port of the consumable 110.

The smokable material 111 may include, for example, a flavor source, such as tobacco, and an aerosol source. The first wrapping paper 112 with which the smokable material 111 is wrapped may be an air-permeable sheet member. The cylindrical member 114 may be a paper tube or a hollow filter. Although the consumable 110 includes the smokable material 111, the cylindrical member 114, the hollow filter 116, and the filter 115 in the illustrated example, the structure of the consumable 110 is not limited to this. For example, the hollow filter 116 may be omitted, and the cylindrical member 114 and the filter 115 may be arranged adjacent to each other.

Next, the internal structure of the flavor inhaler 100 will be described. FIG. 3 is a sectional view of the flavor inhaler 100 taken along line 3-3 FIG. 1B. In FIG. 3, the slide cover 90 is at the closed position. As illustrated in FIG. 3, an inner housing 10 is accommodated in the outer housing 101 of the flavor inhaler 100. Examples of the material of the inner housing 10 include resins, in particular, polycarbonate (PC), acrylonitrile-butadiene-styrene (ABS) resin, and polyether ether ketone (PEEK), polymer alloys containing multiple types of polymer, and metals, such as aluminum. To ensure sufficient heat resistance and strength, the inner housing 10 is preferably made of PEEK. However, the material of the inner housing 10 is not particularly limited. A power supply unit 20 and the atomizing unit 30 are disposed in an internal space of the inner housing 10. Examples of the material of the outer housing 101 include resins, in particular, polycarbonate (PC), acrylonitrile-butadiene-styrene (ABS) resin, and polyether ether ketone (PEEK), polymer alloys containing multiple types of polymer, and metals, such as aluminum.

The power supply unit 20 includes a power supply 21. The power supply 21 may be, for example, a rechargeable or non-rechargeable battery. The power supply 21 is electrically connected to the atomizing unit 30 by, for example, a printed circuit board (PCB) that is not illustrated. Thus, the power supply 21 is capable of supplying electric power to the atomizing unit 30 to appropriately heat the consumable 110.

As illustrated, the atomizing unit 30 includes the chamber 50 (corresponding to an example of a container) extending in the direction of insertion of the consumable 110 (Z-axis direction), a heating unit 40 surrounding a portion of the chamber 50, a heat insulator 32, and an insertion guide member 34 having a substantially cylindrical shape. The chamber 50 is configured to accommodate the consumable 110. The chamber 50 is preferably made of a material that is heat resistant and has a low coefficient of thermal expansion. The material may be, for example, a metal, such as stainless steel, a resin, such as PEEK, glass, or ceramic. As illustrated, the chamber 50 may be provided with a bottom member 36 at the bottom thereof. The bottom member 36 may function as a stopper that positions the consumable 110 inserted in the chamber 50. The bottom member 36 may have an uneven surface that comes into contact with the consumable 110, and may define a space to which air can be supplied on the surface that comes into contact with the consumable 110. The bottom member 36 may be made of, for example, a resin material, such as PEEK, a metal, glass, or ceramic. However, the material of the bottom member 36 is not particularly limited to this. The material of the bottom member 36 may have a thermal conductivity lower than that of the material of the chamber 50. When the bottom member 36 is joined to the bottom of the chamber 50, an adhesive composed of, for example, a resin material, such as epoxy resin, or an inorganic material may be used.

The heating unit 40 includes a sheet-shaped heater, which will be described below, for heating the smokable material 111 in the consumable 110. In the present embodiment, the heater of the heating unit 40 may be disposed to surround the smokable material 111 in the consumable 110. In the present embodiment, the heater of the heating unit 40 may be disposed to surround the chamber 50. More specifically, the heating unit 40 is in contact with an outer peripheral surface of the chamber 50, and is configured to heat the consumable 110 accommodated in the chamber 50. The heating unit 40 may also include a heat insulating member positioned outside the sheet-shaped heater or a shrinkable tube that fixes the heater and other components to the chamber 50. The heating unit 40 may include an electrically insulating member made of, for example, polyimide that covers one or both surfaces of the sheet-shaped heater.

The heater of the heating unit 40 is configured to heat the smokable material 111 in the consumable 110 accommodated in the chamber 50 from the outside. The heater of the heating unit 40 may be provided on either an outer surface or an inner surface of a side wall of the chamber 50.

The heat insulator 32 has a substantially cylindrical shape overall and is disposed to surround the chamber 50 and the heating unit 40. The heat insulator 32 may include, for example, an aerogel sheet. The heat insulator 32 is separated from the chamber 50 and the heating unit 40, and is spaced from the chamber 50 and the heating unit 40 by an air layer. The insertion guide member 34 may be formed of a resin material, such as PEEK, PC, or ABS, and is disposed between the slide cover 90 at the closed position and the chamber 50. The flavor inhaler 100 includes a first holder 37 and a second holder 38 for holding the heat insulator 32. The first holder 37 and the second holder 38 may be made of, for example, an elastomer, such as silicone rubber. As illustrated in FIG. 3, the first holder 37 holds an end portion of the heat insulator 32 in a positive Z-axis direction. The second holder 38 holds an end portion of the heat insulator 32 in a negative Z-axis direction.

The insertion guide member 34 has a function of guiding insertion of the consumable 110. More specifically, when the slide cover 90 is at the open position, the insertion guide member 34 communicates with the opening 101a in the flavor inhaler 100 illustrated in FIG. 1B. When the consumable 110 is inserted into the insertion guide member 34, the insertion guide member 34 guides insertion of the consumable 110 into the chamber 50. In the present embodiment, the insertion guide member 34 may be in contact with the chamber 50. Therefore, to ensure sufficient heat resistance, the insertion guide member 34 is preferably made of PEEK.

The flavor inhaler 100 includes a first chassis 22 extending between the power supply 21 and the atomizing unit 30 in the Z-axis direction and a second chassis 23 extending to cover the power supply 21 along a side adjacent to the slide cover 90. The first chassis 22 and the second chassis 23 are configured to define a space accommodating the power supply 21 in the inner housing 10.

The heater of the heating unit 40 will now be described in detail. FIG. 4 is a schematic profile of the heater. As described above, an external heater according to the related art may include conductive tracks as resistive heating elements, and it has been difficult to uniformly heat the consumable 110 due to distribution of the conductive tracks along a plane of the external heater. Accordingly, a heater 41 of the present embodiment is configured to produce heat in response to a current flowing therethrough in a direction orthogonal to the surfaces of the sheet-shaped heater 41. More specifically, the heater 41 has a main surface 41a and an end surface 41b, and is configured to produce heat in response to a current flowing therethrough in a direction orthogonal to the main surface 41a. Thus, the heater 41 produces heat in response to a current flowing therethrough in the direction orthogonal to the main surface 41a instead of an in-plane direction of the heater 41. Therefore, when the resistance of the heater 41 is constant along the plane of the heater 41, heat can be produced uniformly over a region through which the current flows. Although the heater 41 has a substantially rectangular shape in plan view in the illustrated example, the heater 41 may have any shape as long as the smokable material 111 in the consumable 110 can be heated.

More specifically, as illustrated in FIG. 4, the heater 41 preferably includes a heater element 42 and a pair of electrodes 45 disposed on both surfaces of the heater element 42 to allow a current to flow therebetween. More specifically, the pair of sheet-shaped electrodes 45 are disposed on both surfaces of the sheet-shaped heater element 42 such that the pair of electrodes 45 face each other with the heater element 42 disposed therebetween. In other words, the sheet-shaped heater element 42 and the pair of sheet-shaped electrodes 45 are laminated together such that the heater element 42 is sandwiched between the pair of sheet-shaped electrodes 45. Since the electrodes 45 are disposed on both surfaces of the heater element 42, the heater 41 produces heat in response to a current flowing from one of the electrodes 45 to the other electrode 45 in the direction orthogonal to the main surface 41a of the heater element 42. Therefore, a region of the heater element 42 on which the electrodes are provided can produce heat in response to a current flowing therethrough in a direction orthogonal to the surfaces of the heater element 42. In other words, the region of the heater element 42 on which the electrodes 45 are disposed can be used as a heating region.

In the example illustrated in FIG. 4, each of the electrodes 45 is sheet-shaped, and the heater element 42 and the electrodes 45 have the same shape (area) in plan view. However, the heater element 42 and the electrodes 45 are not limited to this. More specifically, for example, in plan view of the electrodes 45 in a flat shape as illustrated in FIG. 4, portions of the electrodes 45 that are fixed to the heater element 42 may be positioned inside the heater element 42 on the surfaces on which the electrodes 45 are disposed in plan view of the electrodes 45. In this case, the portions of the sheet-shaped electrodes 45 that are fixed to the heater element 42 are disposed so as not to protrude from the heater element 42 in plan view of the electrodes 45. Therefore, the pair of electrodes 45 can be prevented from extending beyond the heater element 42 to come into contact with each other (be short-circuited to each other).

As illustrated in FIG. 4, each electrode 45 may include a conductive adhesive 43. Thus, the conductive adhesive 43 itself can constitute the electrodes 45. Alternatively, the conductive adhesive 43 can be used to bond any conductive member (for example, metal foils 44 illustrated in FIG. 4) to the heater element 42 as the electrodes 45. In the present embodiment, each of the pair of electrodes 45 includes the conductive adhesive 43. However, the pair of electrodes 45 are not limited to this, and may be structured such that at least one thereof includes the conductive adhesive 43. The conductive adhesive 43 may be a known conductive adhesive, for example, an organic binder, such as an epoxy resin, containing conductive filler.

As illustrated in FIG. 4, the electrodes 45 may include the metal foils 44. Each metal foil 44 may be fixed to the heater element 42 with the conductive adhesive 43 provided therebetween. Thus, the heater 41 is covered with the metal foils 44, so that the heater 41 can be easily wrapped around the chamber 50 that accommodates the consumable 110. In addition, the emissivity of the surface of the heater 41 is reduced, so that heat loss due to radiation can be reduced. In the present embodiment, each of the pair of electrodes 45 includes the corresponding metal foil 44. However, the pair of electrodes 45 are not limited to this, and may be structured such that at least one thereof includes the metal foil 4. Alternatively, the pair of electrodes 45 may be structured such that neither thereof includes the metal foil 44. In such a case, each of the pair of electrodes 45 may be composed only of the conductive adhesive 43. The metal foils 44 may be made of a low-resistance metal material, such as copper, aluminum, or stainless steel. Conductive members (lead wires) that are not illustrated may be connected to the metal foils 44 so that electric power can be supplied to the metal foils 44 from the power supply 21 illustrated in FIG. 3.

The heater element 42 preferably includes a conductive material and a porous body configured to hold the conductive material. In such a case, the conductive material can be held by being uniformly distributed over the porous body, so that the uniformity of the resistance of the heater element 42 along the plane of the heater element 42 can be increased. In addition, the resistance of the heater element 42 can be easily adjusted by adjusting the type, amount, etc., of the conductive material held by the porous body. Therefore, the heater 41 having a desired resistance can be obtained. The conductive material may be held by being non-uniformly distributed over the porous body so that the resistance of the heater 41 varies along an in-plane direction. In such a case, the heater 41 can heat a desired portion of the consumable 110 to a temperature higher than the temperature of other portions.

The porous body is preferably formed of inorganic fibers. In such a case, the heater element 42 can be structured such that the conductive material is held by being uniformly distributed over the porous body and that the heat resistance of the heater element 42 is sufficiently high (for example, 300° C. or more). The inorganic fibers may be, for example, glass fibers, amorphous fibers, such as rock wool fibers, carbon fibers, or ceramic fibers, such as alumina fibers. The inorganic fibers are preferably made of an insulating material. In such a case, the volume resistivity of the heater element 42 is not likely to be excessively low. In this case, the heater element 42 can have an appropriate resistance, and the area and thickness of the heater element 42 can be increased, so that the heater 41 that is strong and capable of heating a larger area can be obtained. In addition, the heater 41 can be more easily manufactured. Therefore, fibers made of an insulating material, such as glass fibers, amorphous fibers, and ceramic fibers, are preferably used as the inorganic fibers.

The conductive material held by the porous body may be a metal material, but preferably includes a substance containing carbon. In such a case, the volume resistivity of the heater element 42 is less likely to be excessively low compared to when the conductive material is made only of a metal material. Therefore, the heater element 42 can have an appropriate resistance, and the area and thickness of the heater element 42 can be increased, so that the heater 41 can be more easily manufactured. The conductive material preferably includes carbon nanotubes. In such a case, the heater element 42 can be sufficiently heat resistant, and the volume resistivity of the heater element 42 can be easily adjusted by adjusting the length and amount of the carbon nanotubes. Therefore, a heating profile close to a desired heating profile can be achieved without greatly changing a voltage applied to the heater element 42.

The heater element 42 of the heater 41 illustrated in FIG. 4 preferably has a volume resistivity of 0.1 m·Ω or more and 18 m·Ω or less. When the volume resistivity of the heater element 42 is in this range, the heater 41 can be formed to have an appropriate thickness and an area corresponding to the size of a widely available consumable 110, and the heater element 42 can have a resistance such that the smokable material 111 in the consumable 110 can be appropriately heated.

The sheet area of the heater 41 may be, for example, 100 mm² or more and 900 mm² or less. The resistance of the heater 41 may be, for example, 0.5 Ω or more and 2.0 Ω or less. The thickness of the heater element 42 of the heater 41 may be, for example, 0.1 mm or more and 0.5 mm or less.

The heater 41 is preferably flexible. The minimum bend radius of the heater 41 is preferably 3 mm or less. In such a case, the heater 41 can be easily bent to surround a widely available consumable or the chamber 50 that accommodates the widely available consumable.

FIG. 5 is a schematic sectional view of the chamber 50 in which the consumable 110 is accommodated. In the illustrated example, the heater 41 is wrapped around the outer surface of the chamber 50. The smokable material 111 in the consumable 110 is at the bottom of the chamber 50. As illustrated, the electrodes 45 of the heater 41 preferably extend to a location downstream of a downstream end portion 111a of the smokable material 111 in a length direction of the smokable material 111. In such a case, the downstream end portion 111a of the smokable material 111 can be reliably heated by the heater 41. Therefore, concentration of vapor or aerosol at the downstream end portion 111a of the smokable material 111 can be reduced, so that the amount of vapor or aerosol that is delivered can be increased.

As illustrated, the electrodes 45 of the heater 41 preferably do not overlap an upstream end portion 111b of the smokable material 111 in the length direction of the smokable material 111. In such a case, the upstream end portion 111b of the smokable material 111 is not directly heated by the heater 41, so that generation of vapor or aerosol from the end portion 11b of the smokable material 111 can be reduced. Therefore, leakage of vapor or aerosol from the end of the consumable 110 can be reduced.

Heaters 41 according to other embodiments will now be described. FIG. 6 is a schematic profile of a heater 41 according to another embodiment. The heater 41 illustrated in FIG. 6 includes a pair of electrodes 45, one of which has a structure different from that in the heater 41 illustrated in FIG. 4. More specifically, one of the pair of electrodes 45 included in the heater 41 illustrated in FIG. 6 includes the chamber 50 instead of the metal foil 44. The heater 41 may be structured such that one of the electrodes 45 is formed by bonding the metal foil 44 to one surface of the heater element 42 with the conductive adhesive 43 provided therebetween and that the other one of the electrodes 45 is formed by bonding the chamber 50 to the other surface of the heater element 42 with the conductive adhesive 43 provided therebetween. In this case, the chamber 50 may be made of a conductive material, such as stainless steel. In the embodiment illustrated in FIG. 6, a current can be applied to the conductive adhesive 43 and the heater element 42 through the chamber 50, so that the heat capacity of the heater 41 can be reduced compared to when the metal foil 44 is used. Therefore, the heating efficiency of the heater 41 can be increased.

FIG. 7 is a schematic profile of a heater 41 according to another embodiment. The heater 41 illustrated in FIG. 7 includes a pair of electrodes 45, both of which have structures different from those in the heater 41 illustrated in FIG. 4. More specifically, one of the pair of electrodes 45 included in the heater 41 illustrated in FIG. 7 includes the chamber 50, and the other of the pair of electrodes 45 includes no metal foil 44. The heater 41 may be structured such that one of the electrodes 45 is formed by applying the conductive adhesive 43 to one surface of the heater element 42 and that the other one of the electrodes 45 is formed by bonding the chamber 50 to the other surface of the heater element 42 with the conductive adhesive 43 provided therebetween. In this case, the chamber 50 may be made of a conductive material, such as stainless steel. The conductive adhesive 43 on one surface of the heater element 42 may be dried so that the conductive adhesive 43 itself serves as the electrode 45. In the embodiment illustrated in FIG. 7, a current can be applied to the conductive adhesive 43 and the heater element 42 through the chamber 50 or the conductive adhesive 43, so that the heat capacity of the heater 41 can be reduced compared to when the metal foil 44 is used. Therefore, the heating efficiency of the heater 41 can be increased.

In the example illustrated in FIG. 7, a conductive element 46 may be connected to the electrode 45 composed only of the conductive adhesive 43. As illustrated, the conductive element 46 includes a portion connected to the conductive adhesive 43, and extends from the conductive adhesive 43 to the outside of the heater 41. Thus, in the example illustrated in FIG. 7, a current can be applied to the conductive adhesive 43 and the heater element 42 through the conductive element 46, so that the heat capacity of the heater 41 can be reduced compared to when the metal foil 44 is used. Therefore, the heating efficiency of the heater 41 can be increased.

A method for manufacturing the heaters 41 illustrated in FIGS. 4, 6, and 7 will now be described. FIG. 8 is a flowchart of a method for manufacturing the heaters 41. First, as illustrated in FIG. 8, a sheet of a porous body formed of, for example, inorganic fibers is prepared (step S801). The inorganic fibers may be made of the above-described materials. Next, the sheet is impregnated with liquid containing a conductive material and caused to hold the conductive material (step S802). The liquid containing the conductive material may be, for example, carbon-containing liquid, more specifically, liquid in which carbon nanotubes are dispersed. Then, the solvent of the liquid containing the conductive material with which the sheet is impregnated is evaporated, so that the conductive material is held by the porous body. Subsequently, the conductive adhesive 43 is applied to the sheet holding the conductive material (step S803).

Then, for example, the metal foil 44 may be bonded to the sheet with the conductive adhesive 43 provided therebetween (step S804). More specifically, the metal foil 44 may be bolded to at least one surface of the sheet with the conductive adhesive 43 provided therebetween. For example, the metal foil 44 may be bonded to each surface of the sheet with the conductive adhesive 43 provided therebetween, so that the heater 41 illustrated in FIG. 4 is manufactured. Alternatively, for example, the chamber 50 may be bonded to one surface of the sheet with the conductive adhesive 43 provided therebetween. Thus, the heater 41 illustrated in FIG. 7 may be manufactured. Alternatively, for example, the metal foil 44 may be bonded to one surface of the sheet with the conductive adhesive 43 provided therebetween, and the chamber 50 may be bonded to the other surface of the sheet with 43 provided therebetween. Thus, the heater 41 illustrated in FIG. 6 may be manufactured. Although embodiments of the present invention have been described above, the present invention is not limited to the above-described embodiments, and various modifications are possible within the scope of the technical idea described in the claims, specification, and drawings. Note that any shape or material not described directly in the specification and drawings is still within the scope of the technical idea of the present invention insofar as the effects and advantages of the present invention are obtained.

### REFERENCE SIGNS LIST

41 heater
42 heater element
43 conductive adhesive
44 metal foil
45 electrode
46 conductive element
50 chamber
100 flavor inhaler
110 consumable
111 smokable material

1. A flavor inhaler comprising:
a heater for heating a smokable material, the heater having a main surface and an end surface,
wherein the heater is configured to produce heat in response to a current flowing through the heater in a direction orthogonal to the main surface.

2. The flavor inhaler according to claim 1,
wherein the heater is disposed to surround the smokable material.

3. The flavor inhaler according to claim 1, further comprising:
a container that accommodates a consumable including the smokable material,
wherein the heater is disposed to surround the container.

4. The flavor inhaler according to claim 1,
wherein the heater includes a heater element and a pair of electrodes disposed on both surfaces of the heater element to allow a current to flow between the pair of electrodes, and
wherein the heater element is configured to produce heat in response to a current flowing between the pair of electrodes through the heater element in a direction orthogonal to the surfaces of the heater element.

5. The flavor inhaler according to claim 4,
wherein the electrodes are sheet-shaped, and
wherein, in plan view of the electrodes, portions of the electrodes that are fixed to the heater element are positioned inside the heater element on the surfaces on which the electrodes are disposed.

6. The flavor inhaler according to claim 4,
wherein the heater element includes a conductive material and a porous body configured to hold the conductive material.

7. The flavor inhaler according to claim 6,
wherein the porous body is formed of inorganic fibers.

8. The flavor inhaler according to claim 7,
wherein the inorganic fibers are made of an insulating material.

9. The flavor inhaler according to claim 6,
wherein the conductive material includes a substance containing carbon.

10. The flavor inhaler according to claim 9,
wherein the conductive material includes carbon nanotubes.

11. The flavor inhaler according to claim 4,
wherein at least one of the pair of electrodes includes a conductive adhesive.

12. The flavor inhaler according to claim 11,
wherein at least one of the pair of electrodes includes a metal foil fixed to the heater element with the conductive adhesive provided therebetween.

13. The flavor inhaler according to claim 11, further comprising:
a conductive element that includes a portion connected to the conductive adhesive and that extends from the conductive adhesive.

14. The flavor inhaler according to claim 4,
wherein the electrodes extend to a location downstream of a downstream end portion of the smokable material in a length direction of the smokable material.

15. The flavor inhaler according to claim 4,
wherein the heater element has a volume resistivity of 0.1 m·Ω or more and 18 m·Ω or less.

16. The flavor inhaler according to claim 4, further comprising:
a container that accommodates a consumable including the smokable material,
wherein the heater is disposed to surround the container, and
wherein one of the pair of electrodes includes the container.

17. The flavor inhaler according to claim 1,
wherein the heater is flexible, and
wherein the heater has a minimum bend radius of 3 mm or less.

18. A method for manufacturing a sheet-shaped heater for heating a smokable material, the method comprising:
preparing a sheet formed of a porous body;
impregnating the sheet with liquid containing a conductive material and causing the sheet to hold the conductive material; and
applying a conductive adhesive to the sheet holding the conductive material.

19. The method for manufacturing a heater according to claim 18, further comprising:
bonding a metal foil to the sheet with the conductive adhesive provided therebetween.
